(19) United States
(12) Patent Application Publication
(10) Pub. No.: US 2002/0090049 A1
(43) Pub. Date: Jul. 11, 2002

(54) Support material for radionuclides, method for producing it, and miniaturized radioactive radiation source

(75) Inventors: Andre Hess, Berlin (DE); Werner Schmidt, Berlin (DE)

Correspondence Address: BIRCH STEWART KOLASCH & BIRCH, PO BOX 747, FALLS CHURCH, VA, 22040-0747, US

(73) Assignee: Eurotope GmbH

(21) Appl. No.: 10/086,361

(22) Filed: Mar. 4, 2002

Related U.S. Application Data
(62) Division of application No. 09/436,253, filed on Nov. 9, 1999.
(60) Provisional application No. 60/107,706, filed on Nov. 9, 1998.

(51) Int. Cl. G21C 19/42

(52) U.S. Cl. 376/308

(57) ABSTRACT

A novel support material for radionuclides has a higher capacity for radioactive substances than previously known support materials. Miniaturized radioactive radiation sources made from the support material display an enhanced dose capacity. The support material is made by the mixing of a suitable solid support with a polysaccharide followed by malleabilization.

### DESCRIPTION

The present invention relates to a method for the production of a novel support material for radionuclides having a higher capacity for the radioactive substances than known support materials. Another subject of the present invention is the support material itself and miniaturized radioactive radiation sources having an enhanced dose capacity being produced using said material.

In medical applications, the miniaturization of the radioactive radiation sources is of increasing importance. Inserted miniature sources are used, for instance, in tumour therapy and intravascular brachytherapy, i.e. the exposure of the inner wall of blood vessels to radiation.

There are essentially two known methods of producing miniaturized radiation sources of the strontium 90 isotope. In the production of tabular radiation sources, a mixed precipitation of Ag₂CO₃/⁹⁰SrCo₃/TiO₂ with subsequent malleabilization of the precipitate is used wherein the emerging silver cake is brought into the desired shape. Regarding the production of miniaturized, cylindrically shaped strontium 90 sources, it is known to soak a pre-formed support matrix consisting of titanium dioxide with a ⁹⁰Sr(NO₃)₂ solution, to dry and then to anneal it at a temperature exceeding 1,000° C. In this process, insoluble strontium 90 titanate (⁹⁰SrTiO₃) is generated. This production method is described, for instance, in U.S. Pat. No. 3,439,514 (cf. application examples). These radiation sources are characterized by having an activity of only 5 to 7 mCi per mm³. This activity and the resulting dose capacity is, however, not sufficient for the aforementioned medical applications.

Therefore, it is an objective of the present invention to provide miniaturized radioactive sources having an enhanced dose capacity sufficient for medical applications.

The objective of the present invention is solved with surprising simplicity by providing a modified support material having a porous structure and an enhanced absorption capability for radionuclides and being produced according to a method for producing a support material for radioactive substances, which comprises mixing a solid support material suitable for accommodating radionuclides in a dry state with a polysaccharide in a ratio in between 6:4 to 9:1, adding water until a kneadable mass is obtained, homogenizing, drying and malleabilizing the mass at temperatures ranging between 800 to 1,300° C. until a porous structure is generated. According to the present invention, the addition of a polysaccharide to the support material during heating-out results in a fine porous structure generating an enlarged inner surface. Preferably, the support material used in the production should have an average grain diameter of 80 to 110 μm while the grain diameter of the polysaccharide would preferably be <50 μm.

The support materials used according to the present invention may for instance be titanium dioxide, zirconium dioxide, aluminum oxide, or silicon oxide. However, any solid support materials capable of absorbing radionuclides are generally suitable.

Preferably, starch or cellulose are used as polysaccharides. Particularly in combination with titanium dioxide or zirconium dioxide, starch has proved its suitability as support material.

The water added in applying the method of the present invention may be mixed with a few drops of a preferably 20 percent tenside solution, if necessary, to obtain a better slidability of the mass. The mass is homogenized using common means such as an evacuable kneader which at the same time removes possible air inclusions. If cylindrical support matrices are to be produced, the mass can be brought into the desired shape by extrusion. The kneadable mass may as well be brought into spherical or tubular shapes. Thereafter, the mass is air-dried and then malleablized at a temperature between 800 and 1,300° C. depending upon the support material until a porous structure has been formed.

According to the present invention, the polysaccharide is added by back pick. The support material to polysaccharide ratio ranges between 6:4 to 9:1. In the case of titanium dioxide being used as support material, preferably 70 to 90 percent by mass of titanium dioxide are mixed with 30 to 10 percent by mass of the polysaccharide. The same applies to zirconium dioxide being used as support material. If such a support matrix is soaked in the common manner for example with a ⁹⁰Sr(NO₃)₂ solution, dried and annealed at 1,250° C., a strontium 90 titanate radiation source having an activity of 12-15 mCi/mm³ can be produced.

According to the present invention, the activity of the radiation source can be further enhanced by soaking the support material produced according to the present invention which, if used as a miniaturized radiation source, had a size between 0.6 and 0.8 mm³, in small portions with the radionuclide solution and short-time malleabilization at 800° C. for a maximum of 30 minutes after each soaking step. In case of an activity concentration of 7.5 to 10 mCi/mm³, normally four soaking steps are sufficient to achieve a 20 mCi/mm³ activity of the miniaturized radiation source. After the last soaking step, malleabilization is performed at 1,000 to 1,300° C. (depending upon the support material) for about one hour.

Thereafter, the production process of the radiation source is finished by encapsulation in the common manner, i.e. the support matrix soaked with the radionuclide is inserted into stainless steel vessels of equal shape which are then closed by lids and laser-sealed.

Below, the present invention is described in more detail with implementation examples without restricting the invention to them.

### IMPLEMENTATION EXAMPLES

### Example 1

a) Production of a miniaturized ⁹⁰SrTiO₃ radiation source

70 percent by mass of titanium dioxide having an average grain diameter of 100 μm and 30 percent by mass of starch having a grain diameter of <50 μm are mixed in a dry state and then mixed with water until a kneadable mass has been obtained. Air inclusions are removed in an evacuable laboratory kneader. Thereafter, the mass is extruded through a ceramic jet the diameter of which is adjustable between 0.2 and 20 mm. Then, the air-dried strings are malleabilized for one hour at 900 to 1,000° C. The heating-out of the support material results in a fine porous structure in the titanium dioxide generating an enlarged inner surface. After cooling down, the strings produced are cut to the desired lengths which may range between 0.5 and 50 mm. The resulting and ready body of the desired shape can now be soaked with a radionuclide solution.

b) A support material produced according to a) above having, for example, a size of 0.75 mm³ is soaked with 1.5 pl of a ⁹Sr(NO₃) ₂ solution having a concentration of 7.5 mCi/mm³, then dried and after drying annealed at 1,250° C. The result is insoluble strontium 90 titanate. The activity of this radiation source ranges between 12 and 15 mCi/mm³.

In order to finish the production of a radiation source, the cylindrical activity carrier is inserted in a common manner into a stainless steel tube being closed on one end while the other end is then closed with a disk-shaped lid and laser-welded.

c) A support material produced according to a) above having, for example, a size of 0.75 mm³ is soaked with a ⁹⁰Sr(NO₃)₂ solution having a concentration of 7.5 mCi/μl in small portions of 0.3 to 0.6 μl (pipetting) and following each soaking step is malleabilized at 800° C. for 30 minutes. After cooling down, the next portion of the radionuclide solution can be added by pipetting. The last soaking step (4 steps are sufficient when using a solution having an activity concentration of 7.5 to 10 mCi/μl) is followed by an annealing process at 1,150 to 1300° C. for one hour. During annealing, ceramization and shrinking processes take place which have a decisive and positive influence on the final size and the resistance to mechanical manipulation of the shaped body. The activity of this radiation source amounts to 20 mCi/mm³.

The activity carrier is then encapsulated in the manner described in b) above.

1. A method for producing a support material for radioactive substances, which comprises mixing a solid support material suitable for accommodating radionuclides in a dry state with a polysaccharide in a ratio in between 6:4 to 9:1,
adding water until a kneadable mass is obtained,
homogenizing, drying and malleabilizing the mass at temperatures ranging between 800 to 1,300° C. until a porous structure is generated.

2. The method according to claim 1, wherein after homogenization and before drying, the mass is brought into the desired shape.

3. The method according to claim 1, wherein said solid support material has an average grain diameter of 80 to 110 μm.

4. The method according to claim 3 wherein said average grain diameter is 90 to 100 μm.

5. The method according to claim 1, wherein said solid support material is titanium dioxide (TiO₂), zirconium dioxide (ZrO₂), aluminum oxide (Al₂O₃) or silicon dioxide (SiO₂).

6. The method according to claim 1, wherein said polysaccharide has a grain diameter of <50 μm.

7. The method according to claim 1, wherein said polysaccharide is starch or cellulose.

8. The method according to claim 1, which comprises mixing 70 to 90 percent by mass titanium dioxide as said support material with 30 to 10 percent by mass of the polysaccharide and malleabilizing the kneadable mass at 900 to 1,000° C.

9. A process to manufacture a miniaturized radioactive radiation source, which comprises:
soaking a support material with a radionuclide solution; and
malleabilizing,
wherein the support material is made by:
mixing a solid support material suitable for accommodating radionuclides in a dry state with a polysaccharide in a ratio of between 6:4 to 9:1, adding water until a kneadable mass is obtained, and homogenizing, drying and malleabilizing the mass at temperatures ranging between 800 to 1,300° C. until a porous structure is obtained.

10. The process according to claim 9, wherein the source has an activity greater than 4.8 mCi/mm³.

11. The process according to claim 9, wherein the support material has been subjected to a multiple step soaking with the radionuclide solution, a short time malleabilization at about 800° C. after each soaking step except that the final soaking step and a malleabilization at 1,000-1,000° C. after the final soaking step.

12. The process of claim 11, wherein the source has an activity of about 8 mCi/mm³.

13. The process of claim 9, wherein the radionuclide comprises strontium 90 titanate, strontium 90 zirconate, strontium 90 silicate or strontium 90 aluminate.

14. The process of claim 9, wherein the solid support material has an average grain diameter of 80-110 μm.

15. The process of claim 9, wherein the support material has an average grain diameter of 90-100 μm.

16. The process of claim 9, wherein the solid support material is selected from the group consisting of titanium dioxide (TiO₂), zirconium dioxide (ZrO₂), aluminum oxide (Al₂O₃) and silicon dioxide (SiO₂).

17. The process of claim 9, wherein the polysaccharide has a grain diameter of >50 μm.

18. A process for manufacturing a support material for a miniaturized radioactive radiation source comprising the support material and a radionuclide, which comprises:
mixing a solid support material selected from the group consisting of titanium dioxide (TiO₂), zirconium dioxide (ZrO₂), aluminum oxide (Al₂O₃) and silicon dioxide (SiO₂) with a polysaccharide in a ratio of between 6:4 to 9:1;
adding water until a kneadable mass is obtained; and
homogenizing, drying and malleabilizing the mass at temperatures ranging between 800-1,300° C. until a porous structure is obtained; and
the miniaturized radioactive source is made by a process comprising:
soaking the support material with a radionuclide solution, and
malleabilizing.

19. The process of claim 18, wherein the source has an activity greater than 4.8 mCi/mm³.

20. A process for manufacturing a miniaturized radioactive radiation source comprising a support material and a radionuclide, which comprises:
subjecting the support material to a multiple-step soaking with a radionuclide solution;
malleabilizing for a short time at about 800° C. after each soaking step, except the final soaking step; and
malleabilizing at 1,000-1,300° C. after the final soaking step,
wherein said support material is made by a process comprising:
mixing a solid support material selected from the group consisting of titanium dioxide (TiO₂), zirconium dioxide (ZrO₂), aluminum oxide (Al₂O₃) and silicon dioxide (SiO₂) with a polysaccharide in a ratio of between 6:4 to 9:1;
adding water until a kneadable mass is obtained; and
homogenizing, drying and malleabilizing the mass at temperatures ranging between 800-1,300° C. until a porous structure is obtained.

21. The process of claim 20, wherein the source has an activity of about 8 mCi/mm³.
